(19) United States
(12) Patent Application Publication
(10) Pub. No.: US 2003/0048973 A1
(43) Pub. Date: Mar. 13, 2003

(54) Polarization analyzing apparatus capable of outputting light in analysis

(76) Inventor: Keisuke Asami, Tokyo (JP)

Correspondence Address: FISH & RICHARDSON P.C., 45 ROCKEFELLER PLAZA, SUITE 2800, NEW YORK, NY, 10111, US

(21) Appl. No.: 10/233,639

(22) Filed: Sep. 3, 2002

(30) Foreign Application Priority Data
Sep. 10, 2001 (JP) P.2001-272830

(51) Int. Cl. G02B 6/27; G02B 27/28

(52) U.S. Cl. 385/11; 359/484

(57) ABSTRACT

The improved polarization analyzing apparatus comprises optical dividing member 2 which divides input light launched from an optical input section and an optical output section which supplies a polarization analyzer 1 with part of the light divided by the dividing member and which outputs the remaining light to the outside of the apparatus. A polarization controller 6 is provided in front of the optical dividing element and controlled in accordance with the polarization information from the polarization analyzer so as to retain a desired state of polarization.

### BACKGROUND OF THE INVENTINON

The present invention relates to a polarization analyzer which analyzes the state of polarization of incident light, more particularly to a real-time polarization analyzing apparatus that can output light to the outside as it is analyzed.

Conventional polarization analyzers cannot do more than measuring (analyzing) the state of polarization of incident light, so if SMF (single-mode fiber) is removed from the polarization analyzer after it has measured the state of polarization of the incident light, the measured value will change.

Accordingly, it has been impossible to achieve real-time analysis and measurement of the state of polarization of light as it is actually used.

In addition, the polarization analyzer does not have a polarization control section which operates on the basis of the polarization information from the analyzer, so it has been impossible to maintain a desired state of polarization over a prolonged time period.

As a further problem, a polarization maintaining fiber (PMF) used to stabilize the state of polarization cannot be connected to an external component such as a light source for output to SMF because this introduces a change in the state of polarization within the SMF.

### SUMMARY OF THE INVENTION

An object, therefore, of the invention is to provide a polarization analyzer which can not only perform real-time analysis and measurement of the state of polarization of light as it is actually used and which is also equipped with a polarization control section to have the ability to maintain a desired state of polarization over a prolonged time period.

In order to attain the stated object, the polarization analyzing apparatus of the inventions comprises optical dividing member which divides input light launched from an optical input section and an optical output section which supplies a polarization analyzer with part of the light divided by the dividing member and which outputs the remaining light to the outside of the apparatus; therefore, the apparatus can output light to the outside as it is analyzed (aspect 1).

The polarization analyzing apparatus may further include a condenser lens that condenses the output light being output from the optical output section to an external optical fiber; as a result, parallel light being currently analyzed for the state of polarization can be output to SMF or PMF exterior to the apparatus (aspect 2).

If desired, a polarization controller may be provided in front of the optical dividing element and controlled in accordance with the polarization information from the polarization analyzer so that light retaining a desired state of polarization can be output to SMF or PMF exterior to the apparatus (aspect 3).

If desired, at least one polarizer may be included in the optical path from the optical input section to the optical output section (aspect 4).

The at least one polarizer may be provided with a rotating mechanism that can be set in a desired position or a drive mechanism that causes the polarizer to be inserted into or removed from the optical path (aspect 5).

If desired, light varying/attenuating member may be provided behind the polarizer and controlled in accordance with the output of monitoring the light passing through the polarizer so as to maintain a constant level of optical output from the optical output section (aspect 6).

The monitoring may be performed by supplying a light receiving element with part of the light obtained by dividing the output of the polarizer with the optical dividing element (aspect 7).

The polarization controller may be of a wave plate type (aspect 8).

The optical dividing member may be composed of a non-polarizing beamsplitter (aspect 9).

### BREIF DESCRIPTION OF THE DRAWINGS

FIG. 1 is a diagram showing the configuration of a polarization analyzing apparatus according to a first mode for carrying out the invention;

FIG. 2 is a diagram showing the configuration of a polarization analyzing apparatus according to a second mode for carrying out the invention;

FIG. 3 is a diagram showing the configuration of a polarization analyzing apparatus according to a third mode for carrying out the invention;

FIG. 4 is a diagram showing the configuration of a polarization analyzing apparatus according to a fourth mode for carrying out the invention;

FIG. 5 is a diagram showing the configuration of a polarization analyzing apparatus according to a fifth mode for carrying out the invention;

FIG. 6 is a diagram showing the configuration of a polarization analyzing apparatus according to a sixth mode for carrying out the invention;

FIG. 7 is a diagram showing an example of the polarization analyzer; and

FIGS. 8A to 8B are diagrams showing three examples of the polarization controller.

### DETAILED DESCRIPTION OF THE PREFERRED EMBODIMENTS

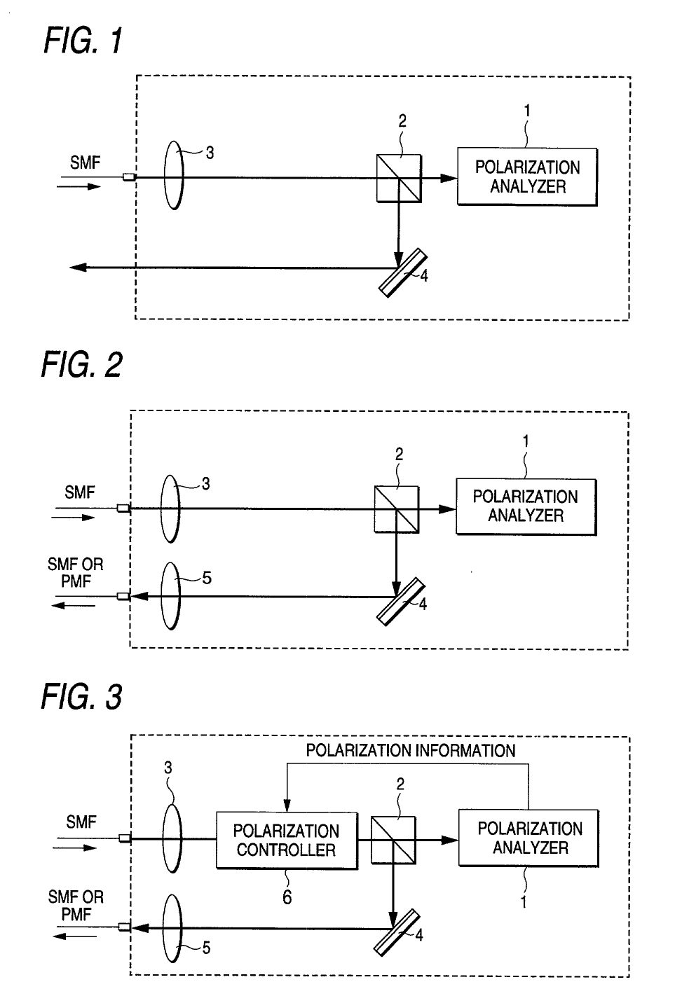

The polarization analyzing apparatus of the invention which is capable of outputting light as it is analyzed is described below with reference to FIGS. 1 to 6.

FIG. 1 is a diagram showing the configuration of a polarization analyzing apparatus according to a first mode for carrying out the invention. Indicated by 1 is a polarization analyzer, 2 is an optical dividing element, 3 is a condenser lens on the input side; and 4 is a mirror (reflecting member).

The light launched over SMF (single-mode fiber) is divided by the optical dividing element 2 and part of it is subjected to analysis and measurement with the polarization analyzer 1.

The remaining part of the light divided by the optical dividing element 2 is reflected by the mirror 4 and output to the outside of the apparatus.

Thus, the polarization analyzing apparatus of the invention is so configured that light can be output to the outside as it is currently analyzed and measured with the polarization analyzer 1 and, in consequence, real-time analysis and measurement of the state of polarization can be performed as light is actually used.

FIG. 2 is a diagram showing the configuration of a polarization analyzing apparatus according to a second mode for carrying out the invention. Indicated by 1 is a polarization analyzer, 2 is an optical dividing element, 3 is a condenser lens on the input side, 4 is a mirror (reflecting member), and 5 is a condenser lens on the output side.

The light launched over SMF (single-mode fiber) is divided by the optical dividing element 2 and part of it is subjected to analysis and measurement with the polarization analyzer 1.

The remaining part of the light divided by the optical dividing element 2 is reflected by the mirror 4 and output to an external component (SMF or PMF) via the condenser lens 5.

Thus, the polarization analyzing apparatus of the invention is so configured that light can be output to the external component (SMF or PMF) via the condenser lens as it is currently analyzed and measured with the polarization analyzer 1 and, in consequence, real-time analysis and measurement of the state of polarization can be performed as light is actually used.

FIG. 3 is a diagram showing the configuration of a polarization analyzing apparatus according to a third mode for carrying out the invention. Indicated by 1 is a polarization analyzer, 2 is an optical dividing element, 3 is a condenser lens on the input side, 4 is a mirror (reflecting member), 5 is a condenser lens on the output side, and 6 is a polarization controller.

The light launched over SMF (single-mode fiber) is subjected to analysis and measurement with the polarization analyzer and the obtained polarization information is fed back to the polarization controller which controls polarization such that light maintaining a desired state of polarization is output to an external component (SMF or PMF) via the condenser lens 5.

Thus, the polarization analyzing apparatus of the invention is so configured that light can be output to the external component (SMF or PMF) via the condenser lens as it is currently analyzed and measured with the polarization analyzer 1 and, in consequence, real-time analysis and measurement of the state of polarization can be performed as light is actually used.

In addition, the polarization analyzer is equipped with the polarization controller which contributes to maintaining a desired state of polarization over a prolonged time period.

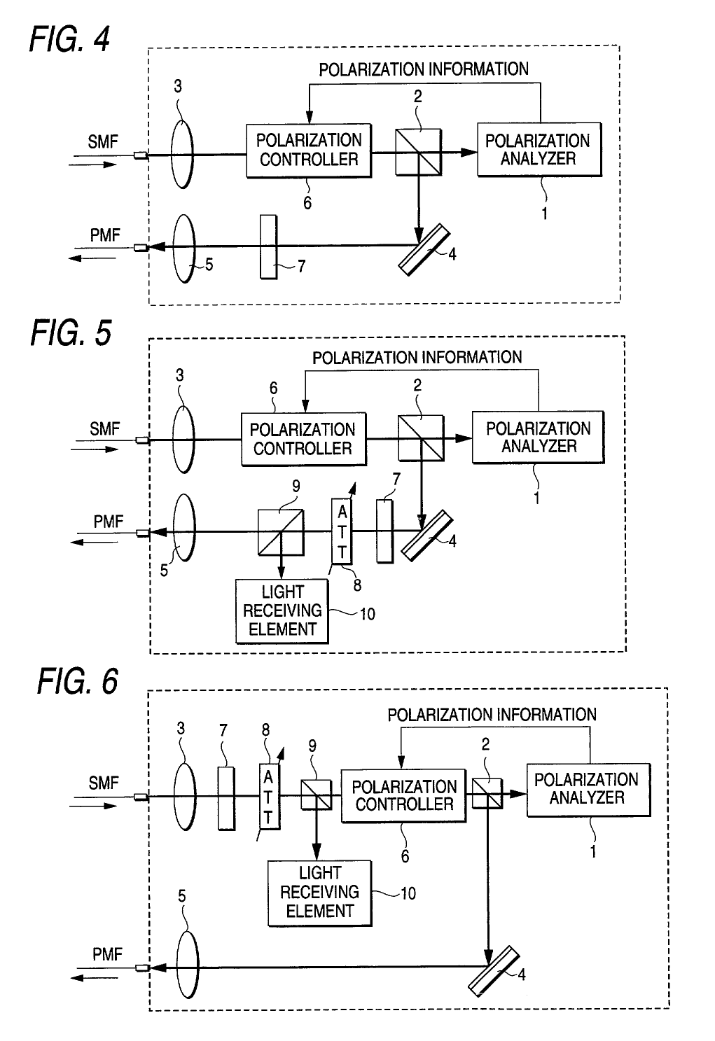

FIG. 4 is a diagram showing the configuration of a polarization analyzing apparatus according to a fourth mode for carrying out the invention. Indicated by 1 is a polarization analyzer, 2 is an optical dividing element, 3 is a condenser lens on the input side, 4 is a mirror (reflecting member), 5 is a condenser lens on the output side, 6 is a polarization controller, and 7 is a polarizer.

The light launched over SMF (single-mode fiber) is subjected to analysis and measurement with the polarization analyzer and the obtained polarization information is fed back to the polarization controller which, controls polarization such that light maintaining a desired state of polarization is linearly polarized by the polarizer 7 and output to an external component (SMF or PMF) via the condenser lens 5.

In FIG. 4, the polarizer 7 is inserted between the mirror 4 and the condenser lens 5 on the output side. This is not the sole position for insertion and a plurality of polarizers may be inserted at any position in the optical system extending from the entrance section to the exit section.

Thus, the polarization analyzing apparatus of the invention is so configured that linearly polarized light can be output to the external component (SMF or PMF) via the condenser lens as it is currently analyzed and measured with the polarization analyzer 1 and, in consequence, real-time analysis and measurement of the state of polarization can be performed as light is actually used.

In addition, the polarization analyzer is equipped with the polarization controller which contributes to maintaining a desired state of polarization over a prolonged time period.

FIG. 5 is a diagram showing the configuration of a polarization analyzing apparatus according to a fifth mode for carrying out the invention. Indicated by 1 is a polarization analyzer, 2 is a first optical dividing element, 3 is a condenser lens on the input side, 4 is a mirror (reflecting member), 5 is a condenser lens on the output side, 6 is a polarization controllers, 7 is a polarizer, 8 is a light varying attenuator (ATT), 9 is a second optical dividing element and 10 is a light receiving element.

The light varying attenuator is so configured that part of the light divided by the optical dividing element is applied to the light receiving element and that the optical output delivered to the outside of the apparatus in accordance with the output of detection with the light receiving element is controlled to have a constant intensity.

Therefore, the light launched over SMF (single-mode fiber) is subjected to analysis and measurement with the polarization analyzer and the obtained polarization information is fed back to the polarization controller which controls polarization such that light maintaining a desired state of polarization is linearly polarized by the polarizer 7 and output to an external component (SMF or PMF) via the condenser lens 5 as it maintains a constant intensity.

Thus, the polarization analyzing apparatus of the invention is so configured that light being currently analyzed and measured with the polarization analyzer 1 is linearly polarized and output to the external component (SMF or PMF) via the condenser lens and, in consequence, real-time analysis and measurement of the state of polarization can be performed as light is actually used.

In addition, the polarization analyzer is equipped with the polarization controller which contributes not only to maintaining a desired state of polarization over a prolonged time period but also to producing a constant intensity of output light.

FIG. 6 is a diagram showing the configuration of a polarization analyzing apparatus according to a sixth mode for carrying out the invention. Indicated by 1 is a polarization analyzer, 2 is a first optical dividing element, 3 is a condenser lens on the input side, 4 is a mirror (reflecting member), 5 is a condenser lens on the output side, 6 is a polarization controller, 7 is a polarizer, 8 is a light varying attenuator (ATT), 9 is a second optical dividing element and 10 is a light receiving element.

The light varying attenuator is provided in front of the polarization controller and so configured that part of the light divided by the optical dividing element is applied to the light receiving element and that the optical output delivered to an external component in accordance with the output of detection with the light receiving element is controlled to have a constant intensity.

Therefore, as in the case shown in FIG. 5, the light launched over SMF (single-mode fiber) is linearly polarized with the polarizer 7 and on the basis of this linearly polarized light, the polarization information obtained by analysis and measurement with the polarization analyzer is fed back to the polarization controller which controls polarization such that light maintaining a desired state of polarization is output to an external component (SMF or PMF) via the condenser lens 5 as it maintains a constant intensity.

Besides, it is preferable to provide the mirror 4 shown in FIGS. 1 to 6 in order to uniform the inputted/outputted directions of the light. However, the mirror 4 is not an essential element of the present invention.

Thus, the polarization analyzing apparatus of the invention is so configured that light being currently analyzed and measured with the polarization analyzer 1 is linearly polarized and output to the external component (SMF or PMF) via the condenser lens and, in consequence, real-time analysis and measurement of the state of polarization can be performed as light is actually used.

In addition, the polarization analyzer is equipped with the polarization controller which controls polarization on the basis of polarization information; this contributes not only to maintaining a desired state of polarization over a prolonged time period but also to producing a constant intensity of output light.

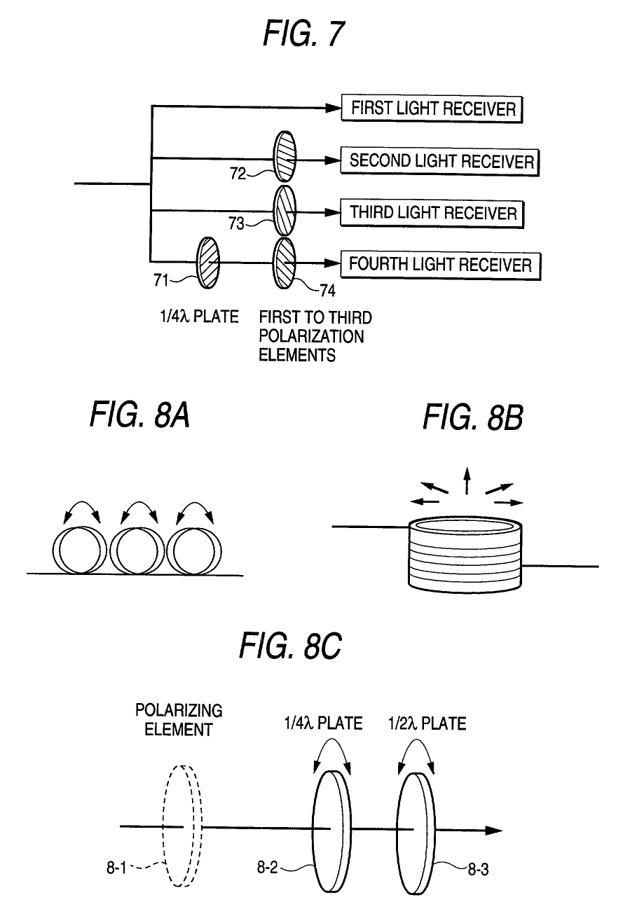

We now describe an example of the polarization analyzer with reference to FIG. 7.

FIG. 7 shows the case of differentiating between various states of polarization on the basis of Stokes parameters. As shown, input light is applied to four different light receivers in different ways; it is applied directly to light receiver (1); it is applied to light receiver (2) via a first polarizer 72; it is applied to light receiver (3) via a second polarizer 73 oriented at a different angle than the first polarizer 72; it is applied to light receiver (4) via a ¼ λ plate 71 and a third polarizer 74 oriented at a different angle than the first polarizer 72 and the second polarizer 73. Various states of polarization are differentiated by processing the outputs of the respective light receivers.

We also describe several examples of the polarization controller with reference to FIG. 8.

FIG. 8A shows a fiber-loop type polarization controller which can change the state of polarization by moving a fiber in a plurality of loops in the directions indicated by arrows.

FIG. 8B shows a piezoelectric bobbin-type polarization controller which changes the state of polarization by causing PMF around a bobbin of piezoelectric element to be given a varying amount of tension as the piezoelectric element expands.

The two types of polarization controller, however, have difficulty in reproducing the state of polarization since there is no regularity in the way the state of polarization changes when the controllers are moved in the directions indicated by arrows.

FIG. 8C shows a wave plate type polarization controller which changes the state of polarization by first linearly polarizing input light with a polarizer 8-1 and then changes the angle of rotation of a ¼λ plate 8-2 and a ½λ plate 8-3; this type of polarization controller is characterized by faithful reproduction of the state of polarization.

When the ¼λ plate is rotated in the directions indicated by arrows, the polarization controller plots a series of points on the great circle of the Poincaré sphere (the ellipticity changes).

If the ½λ is rotated in the directions indicated by arrows, the polarization controller plots a series of points on the equator (the angle of polarization changes).

The polarization analyzing apparatus recited in aspect 1 comprises optical dividing member which divides input light launched from an optical input section and an optical output section which supplies a polarization analyzer with part of the light divided by the dividing member and which outputs the remaining light to an external component; hence, the apparatus can output light to,the outside as it is analyzed and real-time analysis and measurement of the state of polarization can be accomplished.

The polarization analyzing apparatus recited in aspect 2 further includes a condenser lens that condenses the output light being output from the optical output section to an external optical fiber; as a result, parallel light which is currently analyzed for the state of polarization can be output on a real-time basis to SMF or PMF exterior to the apparatus.

The polarization analyzing apparatus recited in aspect 3 further includes a polarization controller in front of the optical dividing element which is controlled in accordance with the polarization information from the polarization analyzer such that light retaining a desired state of polarization in a consistent manner over a prolonged time period can be output to SMF or PMF exterior to the apparatus.

The polarization analyzing apparatus recited in aspect 4 further includes at least one polarizer in the optical path from the optical input section to the optical output section. In the polarization analyzing apparatus recited in aspect 5, the at least one polarizer is provided with a rotating mechanism that can be set in a desired position or a drive mechanism that causes the polarizer to be inserted into or removed from the optical path. As a result, linearly polarized light of enhanced extinction factor can be output to an output fiber PMF in agreement with its axis of polarization and the polarizer can be easily inserted into or removed from the optical path as the state of polarization is analyzed and measured.

The polarization analyzing apparatus recited in aspect 6 further includes light varying/attenuating member behind the polarizer which is controlled in accordance with the output of monitoring the light passing through the polarizer so as to maintain a constant level of optical output from the optical output section; in addition, light retaining a desired state of polarization in a consistent manner over a prolonged time period can be output to SMF or PMF exterior to the apparatus.

In the polarization analyzing apparatus recited in aspect 7, the monitoring is performed by supplying a light receiving element with part of the light obtained by dividing the output of the polarizer with the optical dividing element. In the polarization analyzing apparatus recited in aspect 8, the polarization controller is of a wave plate type. In this case, the state of polarization is changed by first linearly polarizing input light with a polarizer 8-1 and then changing the angle of rotation of a ¼λ plate 8-2 and a ½λ plate 8-3; as a result, analysis and measurement can be performed to achieve faithful reproduction of the state of polarization.

In the polarization analyzing apparatus recited in aspect 9, the optical dividing member is composed of a non-polarizing beamsplitter. As a result, the change in transmission loss due to variations in the polarization of incident light is made sufficiently small that the incident light can be transmitted while maintaining the initial state of polarization.

Thus, by using the polarization analyzer of the invention, the state of polarization can be monitored and controlled on a real-time basis, realizing the heretofore impossible SMF to PMF connection.

What is claimed is:

1. A polarization analyzing apparatus capable of outputting light in analysis, comprising:
an optical dividing member which divides input light launched from an optical input section; and
an optical output section which supplies a polarization analyzer with part of the light divided by said dividing member, and which outputs the remaining light to the outside of said apparatus.

2. The polarization analyzing apparatus according to claim 1, further comprising:
a condenser lens that condenses the output, light being output from said optical output section to an external optical fiber.

3. The polarization analyzing apparatus according to claim 1, further comprising:
a polarization controller in front of said optical dividing element, said polarization controller being controlled in accordance with the polarization information from said polarization analyzer so as to retain a desired state of polarization.

4. The polarization analyzing apparatus according to claim 1, further comprising:
at least one polarizer in the optical path from said optical input section to said optical output section.

5. The polarization analyzing apparatus according to claim 4, wherein
said at least one polarizer includes:
a rotating mechanism that can be set in a desired position, or a drive mechanism that causes the polarizer to be inserted into or removed from the optical path.

6. The polarization analyzing apparatus, according to claim 1, further comprising:
a light varying/attenuating member behind said polarizer, said light varying/attenuating member being controlled in accordance with the output of monitoring the light passing through said polarizer so as to maintain a constant level of optical output from said optical output section.

7. The polarization analyzing apparatus according to claim 6, wherein
said monitoring is performed by supplying a light receiving element with part of the light obtained by dividing the output of said polarizer with said optical dividing element.

8. The polarization analyzing apparatus according to claim 3, wherein
said polarization controller is of a wave plate type.

9. The polarization analyzing apparatus according to claim 1, wherein
said optical dividing member comprises:
a non-polarizing beamsplitter.

10. The polarization analyzing apparatus according to claim 4, wherein
said polarization controller is of a wave plate type.

11. The polarization analyzing apparatus according to claim 6, wherein
said polarization controller is of a wave plate type.
